(19) United States
(12) Patent Application Publication
(10) Pub. No.: US 2026/0368941 A1
(43) Pub. Date: Nov. 19, 2026

(54) Method and Device for Encoding and Decoding Images

(71) Applicant: ORANGE, ISSY LES MOULINEAUX (FR)

(72) Inventors: Felix HENRY, Chatillon (FR); Theo LADUNE, Chatillon (FR); Pierrick PHILIPPE, Chatillon (FR); Gordon CLARE, Chatillon (FR)

(21) Appl. No.: 19/137,088

(22) PCT Filed: Dec. 5, 2023
(86) PCT No.: PCT/EP2023/084247

§ 371 Date: Jun. 9, 2025

(30) Foreign Application Priority Data
Dec. 9, 2022 (FR) FR2213091

(51) Int. Cl. G06T 9/00; G06T 3/4046

(52) U.S. Cl. CPC G06T 9/002; G06T 3/4046

(57) ABSTRACT

A method and device for encoding and decoding images for coding and decoding a signal including a plurality of samples. The decoding method includes: decoding a first group of feature maps; transforming the first group of feature maps to obtain a second group of feature maps having the resolution of the signal to be decoded; decoding a set of parameters representative of a neural network; for at least one sample, called the current sample, of the signal to be decoded, which is associated with a position in the signal to be decoded: constructing a feature vector from the feature maps of the second group, as a function of the position of the current sample, and processing the feature vector with an artificial neural network defined by the decoded parameters in order to provide a vector representative of a decoded value of the current sample.

### DESCRIPTION

### Prior Art

The invention relates to the general field of coding one-or multi-dimensional signals. It more particularly relates to compression of digital images and video.

Digital images are generally source coded to compress them in order to limit the resources required for their transmission and/or storage. There are many coding standards, such as, for still images, the standards of the JPEG family, and for moving images, or video, the standards of the ITU/MPEG organizations (H.264/AVC, H.265/HEVC, H.266/VVC, etc.) and their extensions (MVC, SVC, 3D-HEVC, etc.).

An image is generally coded by dividing the image into a plurality of rectangular blocks, and by coding these blocks of pixels in a given processing sequence. In existing video-compression techniques, the processing of a block typically comprises making a prediction of the pixels of the block using previously coded then decoded pixels present in the image in the process of being coded (in which case reference is made to “intra prediction”) or in previously coded images (in which case reference is made to “inter prediction”). Exploiting spatial and/or temporal redundancy in this way makes it possible to avoid transmitting or storing the value of the pixels of each block of pixels, by representing at least some of the blocks by a residual representing a difference between the predicted values of the pixels of the block and the actual values of the pixels of the predicted block.

As video formats continue to advance, so as to provide even better compression and to adapt to the variety of expected formats and communication networks, the number of possible predictions is becoming increasingly large and conventional coding and decoding algorithms are becoming very complex.

In addition to these conventional approaches provided for by compression standards (JPEG, MPEG, ITU), approaches based on artificial intelligence, and especially neural approaches, are tending to develop.

Some of these neural approaches may be considered to be a simple extension of the notion of competition between the above-mentioned compression techniques, such as prediction mode competition and transformation in video coding.

Other approaches use the “autoencoder” concept. Autoencoders are learning algorithms based on artificial neural networks, that make it possible to construct a new representation of a dataset. The architecture of an autoencoder consists of two parts: the encoder and the decoder. The encoder consists of a set of layers of neurons, which process the data in order to construct new representations that are said to be “encoded” (they are also called “latent representations”). In turn, the layers of neurons of the decoder receive these representations and filter them in order to attempt to reconstruct the original data. Differences between the reconstructed data and the initial data make it possible to measure the error made by the autoencoder. Training consists in modifying the parameters of the autoencoder in order to reduce the reconstruction error measured on the various samples of the dataset. The performance achieved with such autoencoder-based systems comes at the cost of a considerable increase in memory footprint and in complexity compared with conventional approaches such as those provided for by compression standards. They may have millions of parameters and may require up to one million multiply-accumulate or MAC operations to decode a single pixel. This makes such decoders much more complex than conventional decoders, and this could hinder adoption of learning-based compression.

More recently, a simple coding technique based on a neural network has been described in the article “Compression with Implicit Neural representations” by Emilien Dupont et al. (arXiv:2103.03123). The proposed coding technique consists in adjusting a neural network to an image, quantifying the weights of the network and transmitting them. At the time of decoding, the neural network is evaluated at each pixel position to reconstruct the image. However, such a technique remains inefficient in compression terms.

There is therefore a need for a solution allowing an image or a sequence of images to be coded/compressed in a simple and efficient manner.

### SUMMARY OF THE INVENTION

The invention relates to a coding method as claimed in claim 1 and to a decoding method as claimed in claim 7.

In the context of the invention, by coding what is meant is the operation consisting in representing a set of samples in a compact form carried, for example, by a digital bit stream. By decoding what is meant is the operation consisting in processing a digital bit stream to restore the decoded samples.

By “sample” of the signal, what is meant is a value sampled from the signal. Sampling the signal produces a sequence of discrete values called samples. In the case of an image signal, the sample is called a pixel and may for example be a color pixel conventionally represented by a triplet of values, for example (R,G,B) or (Y,U,V). Generally, a sample is represented by a vector of one or more components, or data.

By “signal comprising a plurality of samples”, what is meant is a signal containing one dimension (audio, sound), two dimensions (image) or more than two dimensions (stereoscopic image, multiscopic image, image associated with a depth map, video, etc.). Depending on this dimensionality, the sample possesses one, two or several coordinates in the signal. In the case of an image signal, the position of the sample is identified by its x- and y-coordinates.

By “feature maps”, what is meant is an abstract representation of the signal comprising a plurality of potentially discrete, variable data that are also called values-real numbers or integers for example. In a known manner, these maps are also referred to as the “latent representation” of the input signal.

By “transforming feature maps”, what is meant is applying a mathematical operation that makes it possible to transform the values of a first map into values of a second map. A first map, called the map of the first group, and which is intended for coding, is of any kind. A second map, called the transformed map, or map of the second group, has the same resolution as the input signal, i.e. it contains as many values as the input signal contains samples (N). The transformation may for example comprise an interpolation, oversampling, filtering, quantization, a Fourier transform, etc.

By “data feature vector constructed from feature maps as a function of a position”, what is meant is a vector consisting of one or more, preferably discrete, elements or data, the data being constructed from the feature maps of the second group in a position determined by the position of the sample being processed in the signal. This feature vector is the one input into the neural network. For example, in the case of a one-dimensional audio signal, such a vector may be constructed from a plurality of values sampled in each of the feature maps at the same coordinate as the sample to be coded. In the case of an image, such a vector may be constructed from a plurality of values sampled in each of the feature maps at the same x- and y-coordinates as the sample to be coded (or decoded).

By “neural network”, what is meant is a neural network such as a convolutional neural network, a multilayer perceptron, an LSTM (acronym of Long Short-Term Memory), etc. The neural network is for example defined by a plurality of layers of artificial neurons that comprise a set of activation, weighting and addition functions (for example, one layer may compute y=f(Ax+b), where y and b are vectors of dimension N, x is a vector of dimension M, A is a matrix of dimension M×N, and f is the activation function). Below, reference will be made to “neural network” or “synthetic neural network”.

By “parameter of the neural network” what is meant is one of the values that characterizes the neural network, for example a weight associated with one of the neurons (filter coefficient, weighting, bias, value affecting the operation of the non-linearity), etc.

By “processing by a neural network” what is meant is applying a function expressed by a neural network to the input feature vector, to produce an output vector representative of the sample to be coded (or decoded). This output vector may contain one or more data representative of the sample.

By “performance measurement”, what is meant is a measurement between at least one value of a sample to be coded and a decoded value of said sample. The measurement may for example evaluate a distortion, or a perceptual error. It may be performed on one sample or on a plurality of samples (for example, the entire image). The measurement may also comprise a measurement of bit rate, in particular the bit rate associated with coding the neural network and/or coding the feature maps of the first group. The measurement may be a conjoint measurement of bit rate and distortion achieved by weighting them. As is well known in the prior art, the value of this measurement is generally minimized until a target value is reached.

By “constructing step”, what is meant is a step that aims to construct parameters representative of the image, before their actual coding. The sub-steps of construction may be reiterated as many times as necessary to obtain an acceptable performance measurement.

Generally, the steps of a coding or decoding process should not be interpreted as being associated with a notion of temporal succession. In other words, the steps may be performed in an order different from that indicated in the independent coding or decoding claim, or even in parallel.

The coding method according to the invention constructs the coding parameters from the input signal, for example an image, by training a neural network on feature vectors associated with a position of a sample to be coded. These feature vectors are constructed from feature maps having the resolution of the input signal. During training, or construction, the parameters of the neural network and the values of the feature maps are updated as a function of a performance measurement, for example of rate-distortion type. When training has ended, i.e. the obtained performance measurement is satisfactory, the actual coding of the parameters of the neural network and/or of the values of the feature maps may be carried out and stored, or transmitted to the decoder.

Advantageously, the training process makes it possible to refine the parameters of the neural network and/or the values of the feature maps until a representation that is adequate in performance terms is obtained (for example until a desired balance is obtained between the generated rate and the distortion experienced by the input signal). The training of the values of the feature maps and the training of the parameters of the neural network may be carried out conjointly. Advantageously, the coding method according to the invention makes it possible to efficiently compress the signal.

Advantageously, the decoding method is simple since it is enough to decode the feature maps of the first group and the neural network to reconstruct a decoded version of the signal (an image for example).

Such a neural network may advantageously be of very simple structure with few parameters.

In addition, the decoding may be performed sample by sample, gradually.

According to embodiments of the coding and/or decoding method:
The method comprises a step of constructing a third group of feature maps and the feature vector is further constructed from said feature maps. Advantageously, these additional maps of the third group, which are constructed identically in the coder and decoder, are neither stored in the coder or transmitted, nor decoded in the decoder. They thus make it possible to employ additional data to improve the compression without degrading the bit rate. They may for example include coordinates, data available in the maps of the first or second group, data regarding other images already processed by the coder or decoder, etc.
At least one of the feature maps of the first group is of lower resolution than that of the signal to be coded (or decoded) and the transforming operation involves oversampling. Advantageously, according to this embodiment, the compression of the feature maps is more efficient since at least one of the feature maps of the first group, to be coded (or decoded) contains fewer values than if it had the resolution of the signal. For example, in the case of a digital image, one of the feature maps in the first group may have a resolution of ½, i.e. it contains half as many x- and y-values as the input signal contains samples, i.e. in total 4 times fewer values than a feature map with the resolution of the signal. In contrast, the feature map of the second group, which corresponds to a transformation of this map of the first group, is of identical resolution to that of the signal. The transformation therefore in this case comprises at least one oversampling operation, so as to obtain the same number of values in the transformed map as the input signal (or signal to be decoded) contains samples.
At least one of said feature maps of the first or third group is of identical resolution to that of the signal to be coded (or decoded). Advantageously, according to this embodiment, at least one of the feature maps has the same resolution as the input signal (or signal to be decoded), allowing high fidelity and respect of the details of the initial resolution of the signal. In this case, the transformation does not change the number of values in the transformed feature map. It may be reduced to an identity transformation (no processing is performed on the values of the map of the first group) or comprise a filtering operation, a quantization operation, a Fourier transformation, etc. In the coding, quantization is essential to correct operation of the system if the feature maps contain, for example, floating or real values. It is necessary to quantize them before they are coded and/or input into the neural network. In contrast, in the decoding, inverse quantization may not be necessary, depending on the embodiment.
Constructing said feature vector comprises a sub-step of extracting a value from said at least one feature map of the second or third group at an identical position to that of the current sample in the signal.

Advantageously, it is thus possible to extract a value from a feature map of the second or third group, at the same position as the sample in the signal (input signal for the coding, signal to be decoded for the decoding), to construct an element of the feature vector. This method is simple to implement. For example, if there are J feature maps of same resolution as the signal, a simple extraction of the values of the maps at the coordinates of the current sample (at the same x-coordinate and same y-coordinate in the feature map) allows the feature vector of J elements to be constructed directly.
Coding (or decoding) said first group of feature maps comprises a substep of entropy coding (or decoding). Advantageously, entropy coding makes it possible to exploit any signal redundancies that may remain in the feature maps, the signal thus being compressed more efficiently.

Correlatively, the invention also relates to a coding device and a decoding device.

The features and advantages of the coding or decoding method apply in the same way to the coding or decoding device according to the invention and vice versa.

The invention also relates to a computer program on a recording medium, this program being able to be implemented in a computer or controller according to the invention. This program comprises instructions configured to implement the corresponding method. This program may use any programming language, and take the form of source code, object code, or code intermediate between source code and object code, such as code in a partially compiled form, or in any other desirable form.

The invention also relates to a computer-readable information medium or recording medium including instructions of the computer program mentioned above. The information or recording media may be any entity or device capable of storing programs. For example, the media may include a storage means, such as a ROM, for example a CD-ROM or a microelectronic circuit ROM, or else a magnetic recording means, for example a floppy disk or a hard disk, a DNA sequence, or a flash memory. Moreover, the information or recording media may be transmissible media such as an electrical or optical signal, which may be routed via an electrical or optical cable, by radio link, by wireless optical link or by other means.

The program according to the invention may in particular be downloaded over the Internet.

Alternatively, each information medium or recording medium may be an integrated circuit in which the program is incorporated, the circuit being designed to execute or to be used in the execution of a method according to the invention.

### BRIEF DESCRIPTION OF THE DRAWINGS

Other features and advantages of the present invention will become apparent from the description given below with reference to the appended drawings, which illustrate examples of embodiment that are in no way limiting.

FIG. 1 schematically shows a coding device used in the context of the invention;

FIG. 2 schematically shows a decoding device used in the context of the invention;

FIG. 3 illustrates one example of a synthetic artificial neural network used in the context of the invention during coding and decoding;

FIG. 4 is a flowchart showing one example of a coding method that may be implemented by the coding device of FIG. 1;

FIG. 5 illustrates a coding method used in one embodiment of the invention;

FIG. 6 illustrates an oversampling method used in one embodiment of the invention;

FIG. 7 is a flowchart showing one example of a decoding method that may be implemented by the decoding device of FIG. 2;

FIG. 8 illustrates a decoding method used in one embodiment of the invention.

### DESCRIPTION OF THE EMBODIMENTS

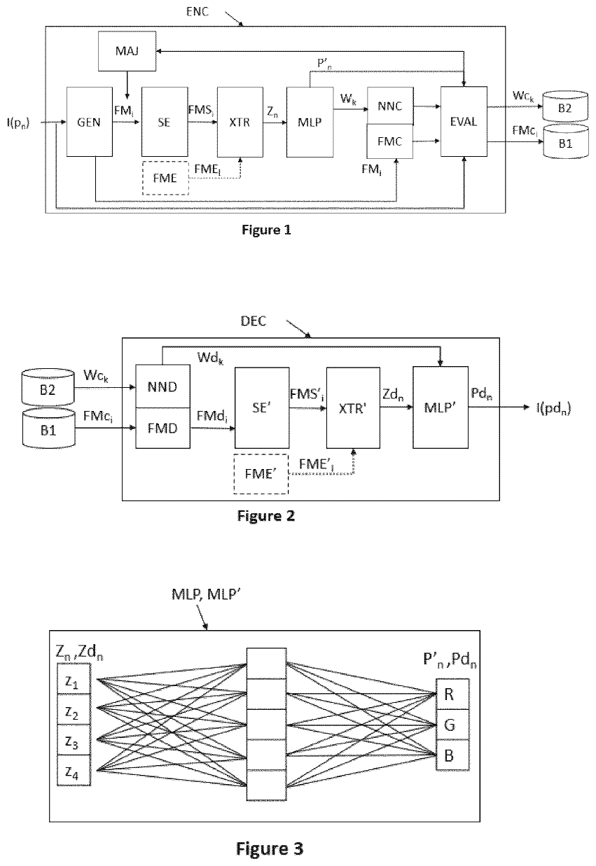

FIG. 1 schematically shows a coding device ENC.

This coding device ENC comprises a module GEN for generating feature maps, a transformation module SE, a data-extracting module XTR, a module MLP corresponding to an artificial neural network, a module NNC for coding the neural network, a module FMC for coding the feature maps, a module EVAL for evaluating a performance function, an updating module MAJ, and an optional module FME for generating additional feature maps.

The coding device ENC may be implemented by means of an electronic device comprising a processor and a memory (which have not been shown); each of the above-mentioned modules may then be realized via interaction of the processor and of computer-program instructions that are stored in the above-mentioned memory and designed to perform the functionalities of the module in question, in particular as described below, when these instructions are executed by the processor.

The coding device ENC of FIG. 1 receives as input a succession of samples to be coded, denoted Pₙ, for example a temporal succession of sound samples, or a set of image data denoted I(Pₙ). In the second case, the image signal I(Pₙ) may represent a two-dimensional image, or a plurality of two-dimensional images (video, color components, stereoscopic components, multiscopic components, etc.). Pₙ denotes one sample n of the input signal, which contains N samples. In one embodiment, the signal is a color-image signal represented by means of at least one two-dimensional representation, such as a matrix of pixels, of width W and of height H (with N=W×H), each pixel having one red component (R), one green component (G), and one blue component (B), or as a variant, one brightness component (Y) and at least one chroma component. The location of each pixel is defined by its x- and y-coordinates (x and y) in the image. In one embodiment, the image is greyscale and represented by means of a two-dimensional representation, such as a matrix of pixels, each pixel having a greyscale or brightness component. In this case, the vector representative of the pixel is reduced to a single component, or datum.

As will be described in greater detail below with reference to FIGS. 3 to 8:

The module GEN for generating feature maps is configured to generate, and in particular initialize, a plurality of M feature maps denoted FMᵢ. The optional module FME may generate one or more additional maps (L in number) which will neither be coded nor transmitted, and which are denoted FMEₗ.

The module SE transforms the first group of feature maps so as to generate a second group of feature maps with the same resolution as the input signal. The module SE may quantize the values of the maps of the first group, by using a quantizer Q to generate an ordered collection of quantized values. It will be recalled that quantization of a value refers to mapping this value to a member of a discrete set of possible code symbols. For example, the set of possible code symbols may consist of integer values, and the quantization system simply rounds an actual value to an integer value. According to another example, quantization consists of multiplication by a given value and then rounding. Next, the module SE performs a transformation of the values of at least one of the feature maps, such as oversampling, interpolation, filtering, etc. At the end of the transformation, a transformed feature map of the second group has the same resolution as the input signal.

The module XTR performs an extraction of values in the feature maps FMSᵢ and optionally FMEₗ, for a sample Pₙ to be coded, as a function of its coordinates in the input signal. The extracted values form the vector Zₙ. Zₙ is a J-tuple, i.e. it contains J elements, or data zᵢ. The vector Zₙ of index n refers to the feature vector of pixel P′ₙ.

The module MLP is a neural network that is defined by K parameters Wₖ, and that is capable of receiving the vector Zₙ, or J-tuple, as input, to generate as output a second vector representative of the sample Pₙ to be coded. According to one embodiment, the neural network is an MLP, or multilayer perceptron, consisting of an input layer adapted to the input format (the J-tuple), optionally one or more hidden layers, and an output layer adapted to the output format of the output vector, generally a vector containing A elements. According to one embodiment, A is equal to 3 and the output vector is the (R,G,B) triplet of the pixel P′ₙ coded and then decoded.

The module NNC codes the neural network, and in particular its parameters Wₖ. During the coding training or construction process, i.e. as long as the step of evaluating performance remains unsatisfactory, the module NNC performs a simulation of coding, followed by decoding, the results of which are sent to the evaluating module. The latter updates the values of the parameters as a function of the results of a performance measurement carried out by the module EVAL. Subsequently, it carries out the actual coding of the parameters Wₖ of the neural network. The coded parameters are denoted Wck. They are stored or transmitted in the form of a stream B2. In a known manner, the coding simulation may be identical to the actual coding, or may approximate it.

The module FMC codes the maps FMi, i.e. quantized values of each map of the first group (excluding the maps FMEₗ). During the coding training or construction process, i.e. as long as the step of evaluating performance remains unsatisfactory, the module FMC performs a simulation of coding, followed by decoding, the results of which are sent to the evaluating module. Subsequently, it carries out the actual coding of the values of the maps FMᵢ. The coded maps are denoted FMcᵢ. They are stored or transmitted in the form of a stream B1. In a known manner, the coding simulation may be identical to the actual coding, or may approximate it. The coding module quantizes, if necessary, the latent representation of the values of the maps of the first group, by using a quantizer to generate an ordered collection of quantized values. Next, the coding module compresses the quantized data, for example using entropy coding.

The module EVAL performs an evaluation and minimization of a coding performance. The evaluation function is for example of rate-distortion type. The minimization may be carried out via a gradient descent, or any other method within the ability of those skilled in the art.

The module MAJ updates the FMI map values to be coded as a function of the results of the performance function.

FIG. 2 schematically shows a decoding device DEC.

The coding device DEC of FIG. 2 receives as input a first group of coded data organized into M feature maps FMcᵢ (also called FM layers) from a stream B1, and the coded parameters Wcₖ of the neural network from a stream B2.

This decoding device DEC comprises a module NND for decoding the neural network, a module FMD for decoding the feature maps, a data-extracting module XTR′, an inverse transformation module SE′, a module MLP′ corresponding to a neural network, and an optional module FME′ for generating additional feature maps.

The maps, or layers, decoded by the module FMD (M in number) are denoted FMdᵢ. The parameters decoded by the module NND are denoted Wdₖ.

The module FME′ of the decoder may also generate one or more additional maps, denoted FME′ₗ, which are L in number, and which are identical to the additional maps FMEₗ generated by the coder.

The module SE′ transforms the first group of decoded feature maps FMdᵢ so as to generate a second group of feature maps with the same resolution as the input signal, which maps are denoted FMS′ᵢ. The module SE′ optionally performs an inverse quantization corresponding to the quantization performed at the coder. The inverse quantization is not necessary if the quantizer Q of the coder simply rounded the actual values submitted to it. The inverse quantization is not necessary either if the neural network is able to take into account quantization of its input data. Otherwise, the decoder performs the inverse operation of the quantizer Q. The module SE′ also performs a transformation of the values of the feature maps, for example oversampling, interpolation, filtering, etc. At the end of the transformation, a transformed feature map of the second group is of same resolution as the signal to be decoded.

The module XTR′ is identical to the module XTR of FIG. 1. It extracts values from the M transformed feature maps FMS′ᵢ and optionally from the L additional maps FME′ₗ, to construct the vector Zₙ which takes the form of a J-tuple for a sample Pₙ to be decoded, as a function of its coordinates in the signal to be decoded. In one embodiment, J=M. In one embodiment, J=M+L.

The module MLP′ is a neural network that is defined by K parameters Wdₖ, and that is capable of receiving the vector Zdₙ, or J-tuple, as input, to generate as output a second vector representative of the sample Pₙ to be decoded, generally a vector containing A elements. According to one embodiment, A=3 and the output vector is the (R,G,B) triplet of the decoded pixel Pdₙ. As a variant, the output vector contains one brightness component (Y) and at least one chroma component. The module MLP′ is of identical structure to the module MLP, and its parameters are either identical if the coding of its parameters Wₖ is lossless, or different if the coding is lossy.

When all the samples Pₙ of the signal have been decoded, a reconstructed signal I(Pdₙ) is obtained, according to one example an image I containing N decoded samples taking the form of N vectors Pdₙ.

The decoding device DEC may be implemented by means of an electronic device comprising a processor and a memory (which have not been shown); each of the above-mentioned modules may then be realized via interaction of the processor and of computer-program instructions that are stored in the above-mentioned memory and designed to perform the functionalities of the module in question, in particular as described below, when these instructions are executed by the processor.

FIG. 3 illustrates one example of a synthetic artificial neural network used for coding and decoding in the context of embodiments of the invention.

The synthetic artificial neural network MLP used for coding and the synthetic artificial neural network MLP′ used for decoding are defined by an identical structure, for example comprising a plurality of layers of artificial neurons, and by a set of weights and activation functions associated with respective artificial neurons of the network in question.

A vector representation of a current sample (a vector Zₙ or Zdₙ obtained from the feature maps FMSᵢ and FMEₗ or FMS′ᵢ and FME′ₗ) is applied to the input (i.e. to an input layer) of the synthetic artificial neural network MLP or MLP′. The artificial neural network produces as output a vector P′ₙ or Pdₙ representative of the decoded sample, according to one embodiment the constituent color components (R, G, B) of a color pixel of an image.

The decoded or reconstructed image is obtained by concatenating all the reconstructed pixels into a (2D, 3D) image.

In the coder, the synthetic artificial neural network MLP is trained on the image, so as to minimize the differences between the input representation of the current image I(Pₙ) and its output representation I(P′ₙ), while also minimizing the amount of data to be coded. The module EVAL performs a performance measurement in this sense.

Once the training has ended, the parameters of the network are coded either losslessly, in which case the neural network MLP′ is identical to MLP, or with losses, in which case the network MLP′ may be slightly different from MLP.

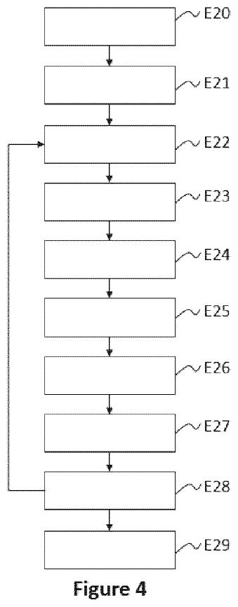

FIG. 4 is a flowchart showing one example of a coding method that may be implemented by the coding device of FIG. 1.

According to this embodiment, the signal is a two-dimensional image, each sample to be coded is therefore a pixel Pₙ of coordinates (xₙ, yₙ).

Encoding takes place in two main phases:

In a first phase, called the construction phase, learning is carried out in order to determine, for an input signal I(Pₙ), the values of the maps FMᵢ and of the parameters Wₖ that optimize an overall cost function. The learning is for example carried out via gradient descent, followed by an update of the parameters of the neural network MLP and of the values of the feature maps FMᵢ. As is known in the prior art, the cost function may be of the rate-distortion type; or rate, or distortion, or perceptual type. To measure the bit rate R, it is necessary to simulate the coding of the maps FMᵢ, then to measure the associated coding bit rate (the size of the stream B1). According to one embodiment, the coding of the parameters Wₖ is not simulated because their influence is less than that of the feature maps. According to one embodiment, the coding of the parameters Wₖ is also simulated and the associated bit rate (the size of the stream B2) is measured. To measure distortion D, it is necessary to simulate the coding and then decoding of at least part of the image I, in order to obtain at least one pixel P′ₙ resulting from a simulation of coding and then decoding, then to measure the difference between this part of the input image I(Pₙ) and a corresponding part of the coded and then decoded image I(P′ₙ).

Next, in a second phase, called the coding phase, the maps FMᵢ and the parameters Wₖ are coded to produce the coded values FMcᵢ and Wcₖ before transmission or storage. They form the compressed representation of the input signal I(Pₙ).

The steps of a method according to one embodiment of the invention will now be described.

In a step E20, a signal I(Pₙ) to be coded, comprising a plurality of N samples Pₙ, is delivered as input to the method.

In a step E21, the M maps FMᵢ of the first group are initialized by the module GEN. Subsequently, the parameters Wₖ of the neural network MLP and the values of the maps FMᵢ must be optimized during the construction phase.

According to one embodiment, the maps FMᵢ have the same resolution as the input signal I(Pₙ) and therefore each contain the same number of values N as there are samples Pₙ to be coded.

According to one embodiment, the maps FMᵢ have a resolution lower than or equal to that of the input signal I(Pₙ) and therefore at least one of them contains a number N′ of values to be coded lower than N.

According to one embodiment, the first map FMᵢ has the resolution of the signal and each subsequent map has a resolution of half the previous one.

According to one embodiment, a plurality of maps FMᵢ have the same resolution, lower than the resolution of the signal.

According to one embodiment, the maps FMᵢ are initialized with predefined constant values.

According to another embodiment, the feature maps are initialized with a set of random real values.

According to one embodiment, one or more maps FMEₗ, forming a third group of L additional feature maps, are generated and added to the first group. They are used to construct the feature vector but will not be stored or transmitted.

These feature maps FMᵢ of the first group are subsequently updated, or refined, in a step E22 by the updating module MAJ of the coder during its learning in the construction phase.

In a step E23, the maps FMᵢ of the first group are coded by the module FMC of the coder. During the construction phase, this operation is a coding simulation. During the coding phase, this operation is actual coding and the coded values form the stream B1. The simulation may be identical to the actual coding but it may also be different (simplified for example). For this coding, it is possible to use any known technique aimed at compressing the values of the maps.

In one embodiment, the maps FMᵢ are coded in the order (FM₁, FM₂, . . . , FM₄), and the variables of each map are coded in a predefined order, a lexicographic order for example. Each map undergoes entropy coding. The entropy coding produces a compressed stream B1 the bit rate of which is subsequently measured in a step E28.

In a step E24, the M maps of the first group FMᵢ are transformed by the module SE to generate maps of the second group FMSᵢ with the resolution of the input signal.

According to one embodiment, M maps FMSᵢ are generated.

According to one embodiment, each map FMᵢ is transformed into a map FMSᵢ.

According to one embodiment, at least one map FMi is of lower resolution than that of the signal to be coded and the transforming operation comprises oversampling so that the transformed map FMSi contains the same number of samples as the input signal. The oversampling consists of adding values to the maps FMSᵢ to achieve the resolution of the input signal. It may be simple (replication of nearest neighbors) or comprise an interpolation (linear interpolation, polynomial interpolation, filtering interpolation, etc.).

In step E25, a vector Zₙ is constructed by the module XTR from the values extracted from the maps FMSᵢ of the second group and optionally FMEₗ of the third group for each sample Pₙ as a function of its coordinates.

In one embodiment, Zₙ contains as many values as there are input maps FMi (and optionally FMEₗ). In this case, J=M(+L).

In one embodiment, Zₙ is a J-tuple (z₁, z₂, . . . , z_{J}) formed from the values of the maps FMSᵢ (and optionally FMEₗ) located at the coordinates (xₙ, yₙ) of the current pixel Pₙ, as will be illustrated with reference to FIG. 5. The value located at the coordinates (xₙ, yₙ) of the map FMSᵢ or FMEₗ gives the final value (zᵢ) of element i of the vector Zₙ relative to this map FMSᵢ or FMEₗ.

The samples to be coded are for example processed in sequential order, from n=1 to n=N.

In a step E26, the vector Zₙ is processed by the neural network MLP to generate as output a vector representative of the sample Pₙ to be coded, according to one embodiment the (R, G, B) triplet of the sample P′ₙ (the sample Pₙ coded and then decoded).

The structure and the parameters Wₖ of the neural network are initialized, for example in the first iteration of this step. These parameters are subsequently updated, or refined, during the construction phase, in subsequent iterations of the process.

According to one embodiment, the parameters of the neural network are initialized with predefined values known to give a satisfactory result (for example, following training on a corpus of images).

According to another embodiment, the parameters Wₖ of the neural network are initialized with a set of random values.

In a step E27, the parameters Wₖ of the neural network MLP are quantized and coded. During the construction phase, this operation is a coding simulation. During the coding phase, this operation is actual coding and the coded values form the stream B2. The simulation may be identical to the actual coding but it may also be different (simplified for example). To this end, any known technique may be used, for example the neural-network coding standard proposed in part 17 of the MPEG-7 standard, a.k.a. Neural Network Representation or NNR. It will be noted that in this case, it is necessary to choose the amount of degradation that the coding causes to the parameters Wₖ.

In a step E28, a performance measurement is evaluated.

To this end, the coding simulation rates associated with the feature maps (simulation of the stream B1 by coding and decoding the maps FMᵢ) and optionally with the parameters of the neural network (simulation of the stream B2 by coding and decoding the parameters Wₖ) are measured.

According to one embodiment, the cost function is of the rate-distortion type, denoted (D+L*R), where D is for example the squared error measured between the input signal and the decoded signal (or the error measured on a subset of samples of the signal). According to another example, D is calculated using a perceptual function such as the SSIM (for Structural SIMilarity) or MSSSIM (for MultiScale Structural SIMilarity). According to one embodiment, R is the simulated bit rate of the stream B1; according to another embodiment, R is the total bit rate used to code this image, i.e. the sum of the simulated bit rates of B1 and B2. L is a parameter that adjusts the rate-distortion compromise. Other cost functions are possible.

Until the cost function reaches its minimum, the performance measurement remains unsatisfactory, and the method is repeated from step E22. This minimization may be carried out via a known mechanism such as gradient descent with parameters updated in step E22 as regards the values of the feature maps and step E26 as regards the parameters of the network.

In a step E29, if the cost function has reached its minimum, the training stops. If a coded version corresponding to the last simulation of the parameters of the neural network (Wₖ) and of the feature maps (FMᵢ) is available, the streams B1 and B2 may be formed therefrom. According to another embodiment, the actual coding of the updated parameters of the neural network (Wₖ) and of the values of the feature maps (FMᵢ) is carried out in this step to produce the coded parameters Wcₖ and FMcᵢ forming the streams B1 and B2.

The streams B1 and B2 may be concatenated to produce a final stream. According to one embodiment, the stream B2 of the coded parameters of the neural network is stored or transmitted before the stream B1, in order to be able to be decoded before the stream B1.

FIG. 5 illustrates a coding method used in one embodiment of the invention to code an image I(Pₙ) (not shown).

In this embodiment, the maps FMᵢ are 4 in number. In one preferred embodiment, they are 7 in number. The map FM₁ has the resolution of the image to be coded. The second map FM₂ has half the resolution (in each dimension) of the map FM₁. Each additional map has half the resolution of the previous map. This structure allows the number of variables in the feature maps to be decreased, this facilitating coding and learning while minimizing coding cost.

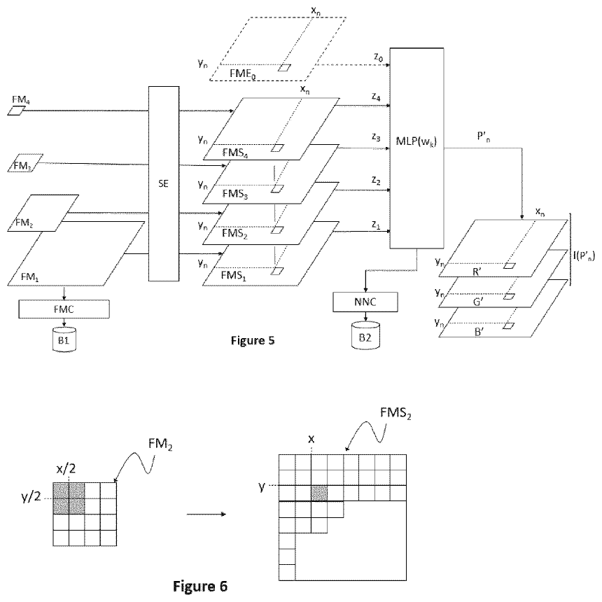

The map FM₂ is oversampled by a factor of 2 in each dimension, using a method illustrated with reference to FIG. 6. The map FM₃ is oversampled by a factor of 4 in each dimension, and the map FM₄ by a factor of 8 in each dimension.

The resulting maps FMSᵢ have the same resolution as the image I(Pₙ), and therefore each contain W×H values, where W is the width of the image in pixels and H its height (N=W×H).

Other types of structure are possible, for example a level of decrease other than one half may be used between maps (one quarter, one third, etc.).

In a variant drawn with dotted lines, the feature maps are 5 in number: an additional map FME₀ has been introduced, which will neither be stored nor transmitted. This additional map typically contains data that may assist the MLP network in the task of reconstructing the signal. Thus, the added maps may be one or more from the following non-limiting list:
A map containing at each point the x-coordinate of this point.
A map containing at each point the y-coordinate of this point.
A map containing positional coding at each point (as described for example at the Internet address https://skosmos.loterre.fr/P66/fr/page/-K0D65X2X-X).
A map representing an image distinct from the image being processed, and capable of providing information on the image to be coded (for example the previously processed image if the current image forms part of a series of images to be coded such as a video, a set of medical images, a multiview representation, etc.).
A map representing a feature map of an image distinct from the image being processed, and capable of providing information on the image to be coded (for example a previously processed map if the current image forms part of a series of images to be coded such as a video, a set of medical images, a multiview representation, etc.).
A map containing the value of an already decoded sample of the same map, for example the previous sample in the decoding order.

In this embodiment, the vector Zₙ is a 4-tuple (z₁ . . . z₄) formed from the values extracted from the maps FMSᵢ located at the coordinates (xₙ, yₙ) of the current pixel Pₙ. The extracted values are quantized and the vector Zₙ formed from the quantized values is processed by the neural network MLP to generate as output a second vector, in the example an (R, G, B) triplet representative of the sample Pₙ to be coded. The output vector is in this case the (R,G,B) triplet of the pixel P′ₙ coded and then decoded. The triplet is inserted into the decoded image I(P′ₙ) at the positions (xₙ, yₙ) of the color components (R′, G′, B′).

In one embodiment, the vector Zₙ is quantized after its extraction.

In another embodiment, the 4 maps FMSᵢ are quantized by the module SE, the vector generated in this case containing already quantized values.

In the variant drawn with dotted lines, the vector Zₙ is a 5-tuple (z₀ . . . z₄), the value z₀ being extracted from the additional map FME₀.

FIG. 6 illustrates an oversampling method used in one embodiment of the invention during coding and decoding.

According to the example illustrated in FIG. 6, the map FM₂ (or FMd₂) of the first group has the resolution ½. The interpolation-based oversampling method generates the image FMS₂ with the same resolution as the input signal.

According to one simple example, in order to generate the value of the map FMS2 at the position (x,y), the values at the positions (x/2, y/2), (x/2−1, y/2), (x/2, y/2−1) and (x/2−1, y/2−1) in the map FM₂ (or FMd₂) are considered and an operation is applied to them to obtain the value FMS₂ (or FMS′₂) at the position (x,y). For example, it may be a question of averaging, interpolation, etc.

Naturally, any oversampling algorithm within the ability of a person skilled in the art may be used.

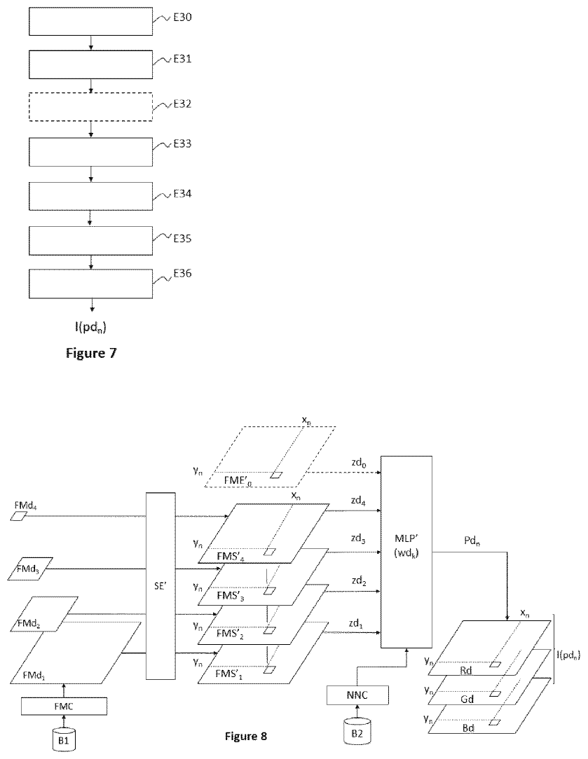

FIG. 7 is a flowchart showing one example of a decoding method that may be implemented by the decoding device of FIG. 2.

In a step E30, the streams B1 and B2 are extracted from the coded stream. They respectively contain the coded representations of the maps of the first group FMcᵢ and of the parameters Wcₖ.

In a step E31, the M maps FMdᵢ are generated by decoding the values FMcᵢ. To do this decoding, it is possible to use any known technique similar to that used in the coder, and preferably entropy decoding. In one embodiment, the maps FMdᵢ are decoded in the order (FMd₁, FMd₂, . . . , FMd₄), and the variables of each map are decoded in a predefined order, a lexicographic order for example.

According to an embodiment equivalent to that described for the coder, the maps FMdᵢ have the same resolution as the signal I(Pdₙ) to be reconstructed and therefore each contain the same number of values N as there are samples Pdₙ to be decoded.

According to an embodiment equivalent to that described for the coder, the maps FMdᵢ have a resolution lower than or equal to that of the signal I (Pdₙ) to be reconstructed.

According to an embodiment equivalent to that described for the coder, the first map FMdᵢ has the resolution of the signal and each subsequent map has a resolution of half the previous one.

According to an embodiment equivalent to that described for the coder, a plurality of maps FMdᵢ have the same resolution, lower than the resolution of the signal.

In a step E32, according to one embodiment, one or more maps FME′ₗ, forming a third group of L additional feature maps, are generated and added to the second group. They are not decoded but generated by the decoder in an identical manner to the way they are generated in the coder. They typically contain data that may assist the MLP′ network in the task of reconstructing the signal. The non-limiting list of possible additional feature maps described with reference to FIG. 4 in the context of the coder is applicable here.

In a step E33, the M maps of the first group FMdᵢ are transformed by the module SE to generate maps of the second group FMS′ᵢ with the resolution of the input signal.

According to an embodiment equivalent to that described for the coder, M maps FMS′ᵢ are generated.

According to an embodiment equivalent to that described for the coder, each map FMdᵢ is transformed into a map FMSᵢ.

According to an embodiment equivalent to that described for the coder, at least one map FMdᵢ is of lower resolution than that of the signal to be coded and the transforming operation comprises oversampling so that the transformed map FMS′i contains the same number of samples as the input signal. The oversampling consists of adding values to the maps FMS′ᵢ to achieve the resolution of the input signal. It may be simple (replication of nearest neighbors) or comprise an interpolation (linear interpolation, polynomial interpolation, filtering interpolation, etc.).

The transformation may optionally comprise an inverse quantization of the extracted values, if necessary. However, inverse quantization is not mandatory.

In step E34, a vector Zdₙ is constructed by the module XTR′ from the values extracted from the maps FMS′ᵢ of the second group and optionally FME′ₗ of the third group for a sample Pₙ to be decoded, as a function of its coordinates (xₙ, yₙ). This step is identical to step E25 that was described in the context of the coder with reference to FIG. 4 and the described embodiments are applicable.

In particular, in one embodiment, Zdn is a J-tuple (z₁, z₂, . . . , z_{J}) formed from the values of the maps FMS′ᵢ (and optionally FME′ₗ) located at the coordinates (xₙ, yₙ) of the current pixel Pₙ, as will be illustrated with reference to FIG. 8. The value located at the coordinates (xₙ, yₙ) of the map FMS′ᵢ gives the final value (zdᵢ) of element i of the vector Zdₙ relative to this map FMS′ᵢ or FME′ₗ.

The extraction may comprise an inverse quantization of the extracted values or of the vector Zdₙ formed, if necessary.

The samples to be decoded are for example processed in sequential order, from n=1 to n=N.

In a step E35, the parameters Wdₖ of the neural network MLP′ are generated by decoding the values Wcₖ of the stream B2. To this end, any known decoding technique corresponding to the coding technique used by the coder may be used. The neural network MLP′ is similar to the network MLP, i.e. it has the same structure and the same parameters, disregarding the coding, which may be lossy or lossless.

According to one embodiment, the stream B2 is decoded before the stream B1, in order to obtain the neural network before starting to decode the samples.

In a step E36, the vector Zdₙ is processed by the neural network MLP′ to generate as output a second vector representative of the sample Pdₙ to be decoded, according to one embodiment a triplet that is injected into the decoded image I(Pdₙ) at the positions (xₙ, yₙ) of the color components (Rd, Gd, Bd). This step is identical to step E26 that was described in the context of the coder with reference to FIG. 4.

When all the samples of the signal have been processed, the decoded signal corresponding for example to the image I(Pdₙ) is obtained.

FIG. 8 illustrates a decoding method used in one embodiment of the invention.

In this embodiment, the maps FMdᵢ are 4 in number. In one preferred embodiment, they are 7 in number.

In this embodiment, the first map FMd₁ has the same resolution as the image I, and therefore contains W×H variables, where W is the width of the image in pixels, and H its height. The second map FMd₂ has half the resolution (in each dimension) of the map FMd₁. Each additional map has half the resolution of the previous map. This structure allows the number of variables in the feature maps to be decreased, this facilitating decoding while minimizing the coding cost.

The map FMd₂ is oversampled by a factor of 2 in each dimension, using a method illustrated with reference to FIG. 6. The map FMd₃ is oversampled by a factor of 4 in each dimension, and the map FMd₄ by a factor of 8 in each dimension.

The maps FMS′ᵢ have the same resolution as the image to be decoded, and therefore contain W×H variables, where W is the width of the image in pixels and H its height.

In this embodiment, the vector Zdn is a 4-tuple (zd₁ . . . zd₄) formed from the values of the maps FMS′ᵢ located at the coordinates (xₙ, yₙ) of the current pixel Pdₙ. The vector Zdₙ is optionally dequantized and then processed by the neural network MLP′ to generate as output a second vector, according to the example an (R, G, B) triplet representative of the sample Pdₙ to be decoded. The (R, G, B) triplet is reinjected into the decoded image I(Pdₙ) at the coordinates (xₙ, yₙ) in the color components (Rd, Gd, Bd).

In a variant drawn with dotted lines, the maps are 5 in number: an additional map FME′₀ has been introduced. In this embodiment, the vector Zdₙ is a 5-tuple.

1. A method for coding a signal comprising a plurality of samples to be coded, implemented by an encoding device and comprising:
constructing a first group of feature maps;
transforming said first group of feature maps to obtain a second group of feature maps with a same resolution as that of the input signal;
for at least one sample, called a current sample, of the signal to be coded, which is associated with a position in the signal to be coded:
constructing a feature vector from said feature maps of said second group, as a function of said position of said current sample;
processing said feature vector with neural network defined by a set of parameters, in order to provide a vector representative of a decoded value of the current sample; and
updating at least one value of one of said feature maps of said first group and/or at least one parameter of said network, as a function of a coding performance measurement, and
coding said first group of feature maps and said set of parameters.

2. The method for coding a signal as claimed in claim 1, wherein the method comprises constructing a third group of feature maps, and the feature vector is further constructed from said feature maps of the third group.

3. The method for coding a signal as claimed in claim 1, wherein at least one of said feature maps of the first group is of lower resolution than that of the signal to be coded and the transforming operation involves oversampling.

4. The method for coding a signal as claimed in claim 1, wherein at least one of said feature maps of the first or third group is of identical resolution to that of the signal to be coded.

5. The method for coding a signal as claimed in claim 1, wherein constructing said feature vector comprises a extracting a value from said at least one feature map of the second or third group at an identical position to that of the current sample in the input signal.

6. The method for coding a signal as claimed in claim 1, wherein coding said first group of feature maps comprises entropy coding.

7. A method for decoding a signal comprising a plurality of samples to be decoded, implemented by a decoding device and comprising:
obtaining, by decoding, a first group of feature maps;
transforming said first group of feature maps to obtain a second group of feature maps with a same resolution as that of the signal to be decoded;
obtaining, by decoding, a set of parameters representative of a neural network; and
for at least one sample, called a current sample, of the signal to be decoded, which is associated with a position in the signal to be decoded:
constructing a feature vector from the feature maps of said second group as a function of said position of said current sample, and
processing said feature vector with the neural network defined by the decoded parameters in order to provide a vector representative of a decoded value of the current sample.

8. The decoding method as claimed in claim 7, wherein the method comprises constructing a third group of feature maps and the feature vector is further constructed from said feature maps of the third group.

9. The decoding method as claimed in claim 7, wherein at least one of said feature maps of the first group is of lower resolution than that of the signal to be decoded and the transforming operation involves oversampling.

10. The method for decoding a signal as claimed in claim 7, wherein at least one of said feature maps of the first or third group is of identical resolution to that of the signal to be decoded.

11. The method for decoding a signal as claimed in any claim 7, wherein constructing said feature vector comprises extracting a value from said at least one feature map of the second or third group at an identical position to that of the current sample in the signal to be decoded.

12. The method for decoding a signal as claimed in claim 7, wherein decoding said first group of feature maps comprises entropy decoding.

13. A device for coding a signal comprising a plurality of samples to be coded, wherein said device comprises:
at least one processor; and
at least one non-transitory computer readable medium comprising instructions stored thereon which when executed by the at least one processor configure the device to:
construct a first group of feature maps;
transform said first group of feature maps to obtain a second group of feature maps with the resolution of the input signal;
for at least one sample, called a current sample, of the signal to be coded, which is associated with a position in the signal to be coded:
construct a feature vector from said feature maps of said second group, as a function of said position of said current sample;
process said feature vector with a neural network defined by a set of parameters, in order to provide a vector representative of a decoded value of the current sample; and
update at least one value of one of said feature maps of said first group and/or at least one parameter of said network, as a function of a coding performance measurement, and
code said first group of feature maps and said set of parameters.

14. A device for decoding a signal comprising a plurality of samples to be decoded, wherein said device comprises:
at least one processor; and
at least one non-transitory computer readable medium comprising instructions stored thereon which when executed by the at least one processor configure the device to:
obtain, by decoding, a first group of feature maps;
transform said first group of feature maps to obtain a second group of feature maps with the resolution of the signal to be decoded;
obtain, by decoding, a set of parameters representative of a neural network and
for at least one sample, called a current sample, of the signal to be decoded, which is associated with a position in the signal to be decoded:
construct a feature vector from the feature maps of said second group, as a function of said position of said current sample, and
process said feature vector with the neural network defined by the decoded parameters in order to provide a vector representative of a decoded value of the current sample.

15. A non-transitory computer readable medium comprising a computer program stored thereon comprising instructions for executing the method for coding as claimed in claim 1 when said program is executed by a computer of the encoding device.

16. A non-transitory computer readable medium comprising a computer program stored thereon comprising instructions for executing the method for decoding as claimed in claim 7 when said program is executed by a computer of the decoding device.
